(19) United States
(12) Patent Application Publication
(10) Pub. No.: US 2007/0119102 A1
(43) Pub. Date: May 31, 2007

(54) Assembly consisting of a carrier part and a door interior part

(75) Inventor: Jens Seibert, Checy (FR)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Light Vehicle Systems-France

(21) Appl. No.: 11/601,218

(22) Filed: Nov. 17, 2006

(30) Foreign Application Priority Data
Nov. 25, 2005 (DE) 20 2005 018 470.5

(51) Int. Cl. B60J 5/04

(52) U.S. Cl. 49/502

(57) ABSTRACT

An assembly includes a carrier part and a door interior part. The carrier part has at least one opening and the door interior part has a one-piece stud capable of engaging in the opening. The one-piece stud has a plastically deformed portion that fastens the carrier part to the door interior part.

### RELATED APPLICATIONS

The application claims priority to German Application No. 20 2005 018 470.5 which was filed on Nov. 25, 2005.

### BACKGROUND OF THE INVENTION

The invention relates to an assembly that includes a carrier part and a door interior part, in particular for a motor vehicle, with the carrier part having at least one opening and the door interior part having a one-piece stud capable of engaging in the opening.

The carrier part is engaged by a carriage of a window lifter system, for instance. For the purpose of a simple installation, components of the window lifter system are pre-assembled on the carrier part and conveyed to a car body as a pre-assembled unit. The pre-assembled unit can then be mounted to the door interior part. The term “door interior part” is to be understood to refer to inner structural parts of lateral portions of the car body, in particular of a vehicle door.

Typically, the carrier parts have been fastened to the door interior part by expensive or multi-part screw connections.

It is the object of the invention to further develop an assembly that includes a carrier part and a door interior part such that a speedier and simpler installation is made possible.

### SUMMARY OF THE INVENTION

This is achieved in an assembly of the type initially mentioned that includes a one-piece stud with a plastically deformed portion that fastens a carrier part to a door interior part. Fastening the carrier part to the door interior part is accomplished as follows: The carrier part is oriented relative to the door interior part such that the one-piece stud, integrally formed with the door interior part, projects through an opening in the carrier part. Then, the one-piece stud is plastically deformed, so that the carrier part is mounted to the door interior part without any additional fastening devices. The plastically deformed portion of the one-piece stud further makes a hermetically sealed connection between the carrier part and the door interior part. Thus, a separate seal is no longer required.

Preferably, a protrusion is provided comprising a bent edge of the carrier part that surrounds the opening. The protrusion is formed in one piece with the carrier part and is a stamped portion thereof. The protrusion reliably resists shearing forces.

The plastically deformed portion may engage behind the carrier part, whereby the carrier part is safely fastened to the door interior part. No additional screw connections will be necessary.

The plastically deformed portion preferably is formed by hot forming. Although “hot forming” is a term from metal working, which is to be understood as a deformation of a work piece by heating, it is also used in the following for plastics deformed by heating.

The carrier part is in particular configured as a rail that is part of a window lifter system, and is made of metal.

According to one embodiment, two openings are provided; a first opening being circular, and a second opening being oval. Two cylindrical studs are provided. A first stud, after positioning the carrier part on the door interior part, circumferentially engages on the protrusion surrounding the first opening. A second stud that is cylindrical engages only in sections on the protrusion surrounding the second opening, which is oval. The second stud can assume various positions in the second opening, whereby manufacturing tolerances of the carrier part can be compensated for in a z-direction.

According to a second embodiment, two openings are provided which both are circular. Here, diameters of the openings correspond to those of the studs.

It is preferred that two recesses are provided in the door interior part, which surround the two studs. One recess is configured as a groove and the other recess takes up an oval region. The protrusions facing the carrier part engage in the recesses after positioning the carrier part on the door interior part. The recess configured as a groove has a diameter that corresponds to that of the protrusion, so that the protrusion circumferentially engages on a wall of the recess. The second recess, however, has a width corresponding to the diameter of the stud and a length that is larger than the diameter of the stud. It is only at a lateral wall of the second recess where the protrusion engages. This is why the stud can slightly “push away” the protrusion, so that manufacturing tolerances of the carrier part in the z-direction can be compensated for in the range of millimeters.

These and other features of the present invention can be best understood from the following specification and drawings, the following of which is a brief description.

### BRIEF DESCRIPTION OF THE DRAWINGS

FIG. 1 shows a schematic cross-section through a vehicle door with an assembly of the invention according to a first embodiment.

FIG. 2 shows an enlarged cut-out of a region, identified by X in FIG. 1, of the assembly according to the invention.

FIG. 3 is a broken view of the assembly according to FIG. 2 prior to mounting a carrier part to a door interior part.

FIG. 4 is a broken view of the assembly according to FIG. 2 prior to deforming a portion.

FIG. 5 shows a top view of the assembly according to FIG. 4.

FIG. 6 is a view, corresponding to FIG. 2, of the assembly of the invention according to a second embodiment.

FIG. 7 is a broken view of the assembly according to FIG. 6 prior to mounting a carrier part to a door interior part.

FIG. 8 is a broken view of the assembly according to FIG. 6 prior to deforming a portion.

FIG. 9 shows a top view of the assembly according to FIG. 8.

### DETAILED DESCRIPTION OF THE PREFERRED EMBODIMENT

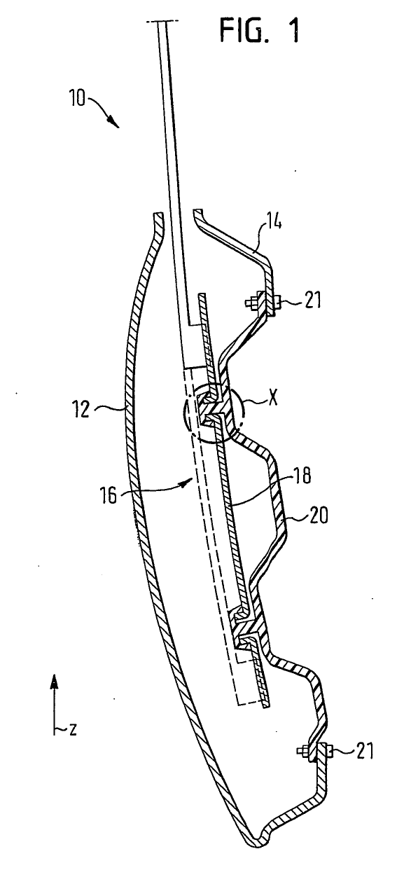

FIG. 1 shows a vehicle door 10 that has a door outer sheet 12 and a door inner sheet 14 as essential structural components. Defined between the door outer sheet 12 and the door inner sheet 14 is a cavity in which components of a window lifter system 16 are arranged.

The door inner sheet 14 is usually comprised of sheet metal, as is already implied by the name. The term “door inner sheet”, however, basically encompasses inner structural parts of a vehicle door, even if these structural parts are not made of metal, but are instead made of plastic, for instance.

A carrier part is configured as a rail 18 that is part of the window lifter system 16. The rail 18 accommodates individual components of the window lifter system 16 and is fastened to a door interior part 20.

The door interior part 20 is configured as a door module, is made of plastic and is mounted to the door inner sheet 14 with a screw, latching or hook connection. A screw connection is schematically shown at 21.

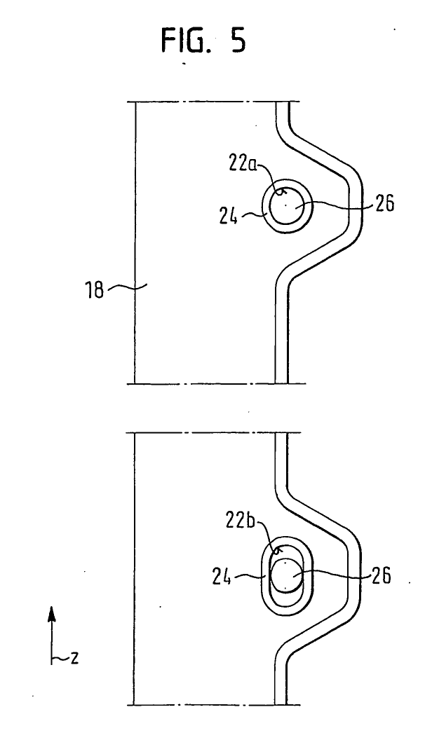

The rail 18 is of metal, in particular sheet metal, and has two openings 22a, 22b (FIG. 5). A first opening 22a is circular and is arranged in an upper region of the rail 18 related to the illustration in FIG. 1. A second opening 22b is oval and is arranged in a lower region of the rail 18. The first and second openings 22a, 22b are developed during punching of the rail 18.

As shown in FIG. 5, the first and second openings 22a, 22b are surrounded by one protrusion 24 each, which is a stamped portion of the rail 18. Here, the protrusion 24 surrounding the first opening 22a is circular, and the protrusion 24 surrounding the second opening 22b is oval.

A diameter of the first opening 22a, which is circular, corresponds to a diameter of a cylindrical stud 26 that is formed in one piece with the door interior part 20 as shown in FIG. 3. A width of the second opening 22b, which is oval shaped, likewise corresponds to a diameter of a stud 26 of the door interior part 20.

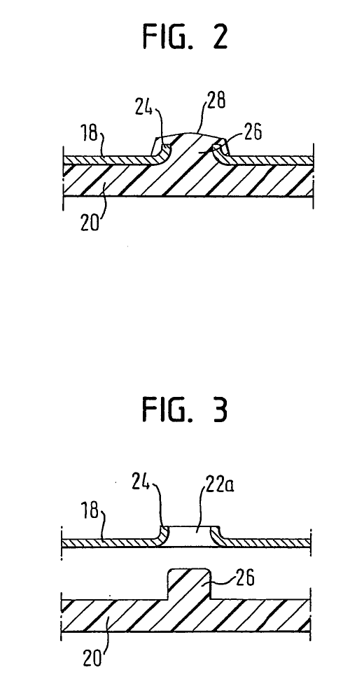

The two studs 26 each have a plastically deformed portion 28, as shown in FIG. 2. The plastically deformed portions 28 can engage behind the rail 18, in particular behind the protrusions 24 (see FIG. 2), so that a connection established between the rail 18 and the door interior part 20 can withstand the existent shearing forces.

The plastically deformed portions 28 are formed by hot forming. Although the term “hot forming” is a term from metal working, the term is also used here for the deformation of the door interior part 20 which is made of plastic.

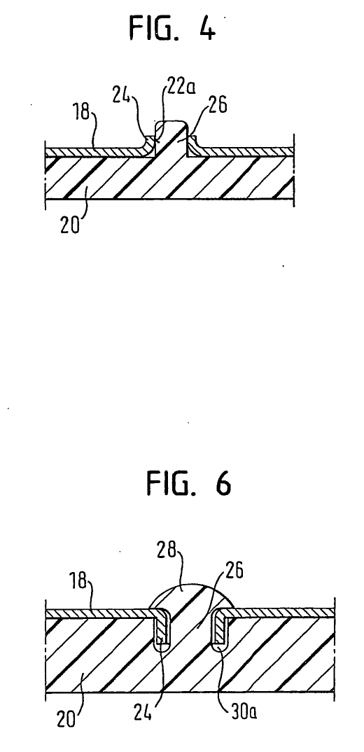

Positioning and attaching the rail 18 to the door interior part 20 is accomplished according to the first embodiment as follows: The rail 18 is oriented such that the two studs 26 of the door interior part 20 engage in the first and second openings 22a, 22b. The protrusions 24, after mounting the rail 18 to the door interior part 20, face away from the door interior part 20 (FIGS. 3 to 5). FIGS. 4 and 5 show the stud 26 that engages in the first opening 22a, which is the upper circular opening related to the illustration in FIG. 1. In this arrangement, an outer surface of the stud 26 circumferentially rests at the protrusion 24.

The lower stud 26 of the door interior part 20, related to the illustration in FIG. 1, engages in the second opening 22b and rests at the oval protrusion 24 only in sections, in particular at side edges (FIG. 5). This stud 26 therefore can assume various positions, and in this way compensates for manufacturing tolerances of the rail 18 in a z-direction.

When the rail 18 is positioned on the door interior part 20, both portions of the studs 26 are plastically deformed by hot forming, so that the plastically deformed portions 28 engage behind the protrusions 24. The connection that is established can resist the occurrence of shearing forces.

FIGS. 6 to 9 show a second embodiment of the assembly including the rail 18 and the door interior part 20.

The differences between the first and second embodiment will be explained in the following. The same reference symbols will be used for those components which are known from the first embodiment, and reference is made in this respect to the above explanations. Both the first and second openings 22a, 22b are circular in this embodiment.

Upper and lower recesses 30a, 30b surround the two cylindrical studs 26. The upper recess 30a, related to these Figures, is groove-shaped and has a diameter that corresponds to that of the stud 26. The lower recess 30b, which surrounds the lower stud 26, related to these Figures, takes up an oval area.

A depth of the upper and lower recesses 30a, 30b corresponds to a height of the protrusions 24, or is selected so as to be somewhat deeper, so that the protrusions 24 can engage in the upper and lower recesses 30a, 30b with their entire height, and the rail 18 engages on the door interior part 20.

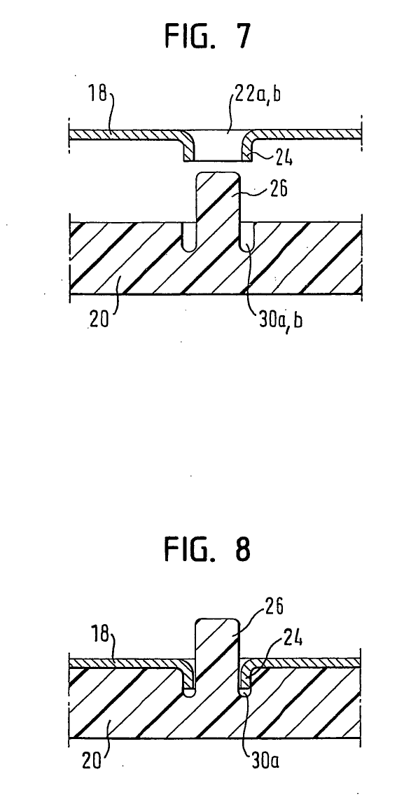

Positioning and fastening the rail 18 to the door interior part 20 is accomplished as follows: The protrusions 24 of the rail 18 face the door interior part 20 and the first and second openings 22a, 22b are oriented such that the studs 26 engage in the first and second openings 22a, 22b (FIGS. 7 to 9).

The upper protrusion 24, related to the illustration in FIG. 1, rests at the outer surface of the stud 26, extends into the upper recess 30a surrounding the stud 26, and circumferentially rests at a wall of the upper recess 30a.

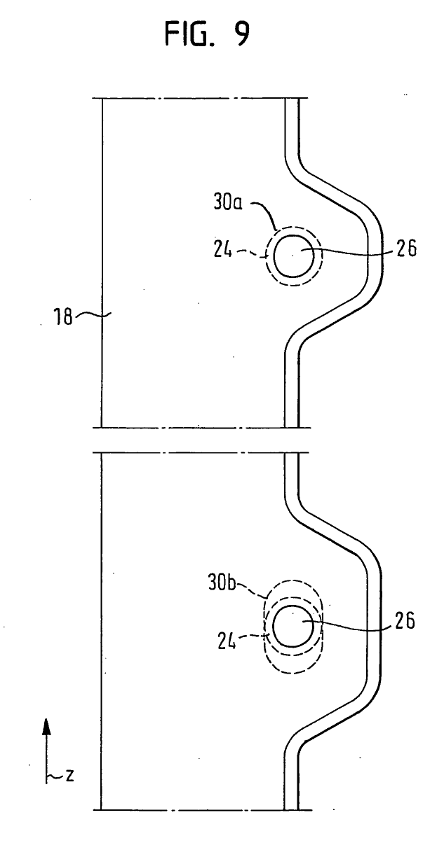

The lower protrusion 24, related to the illustration in FIG. 1, likewise circumferentially engages on an outer surface of the stud 26. The lower protrusion 24, however, only laterally engages a wall that surrounds the lower recess 30b. This is why the stud 26 can slightly “push away” the lower protrusion 24, in order to compensate for manufacturing tolerances of the rail 18 in the z-direction (FIG. 9).

When the studs 26 are positioned in the first and second openings 22a, 22b, the portions will be plastically deformed by hot forming, such that the plastically deformed portions 28 engage behind the rail 18. Thus, the connection between the rail 18 and the door interior part 20 can withstand existing shearing forces.

The embodiments which have been described allow an attachment of the rail 18 on the door interior part 20 without any additional fastening methods or mechanisms.

Also, the rail 18 according to one of the aforementioned embodiments could be fastened to the door inner sheet 14; and the door interior part 20 could be fastened to the door inner sheet 14, too. It is only of importance that the stud 26 has a plastically deformed portion 28.

The carrier part could also be a plate-shaped metal part to which the rail of the window lifter system is fastened. In that case, the metal part according to one of the aforementioned embodiments would be mounted to door interior part 20 which is of plastic.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An assembly comprising:
a carrier part having at least one opening; and
a door interior part having a one-piece stud engageable in the at least one opening, wherein the one-piece stud has a plastically deformed portion that fastens the carrier part to the door interior part.

2. The assembly according to claim 1 wherein the at least one opening is formed by punching.

3. The assembly according to claim 1 including a protrusion comprising a bent edge of the carrier part that surrounds the at least one opening.

4. The assembly according to claim 1 wherein the plastically deformed portion engages behind the carrier part.

5. The assembly according to claim 1 wherein the plastically deformed portion is formed by hot forming.

6. The assembly according to claim 1 wherein the carrier part is configured as a rail.

7. The assembly according to claim 1 wherein the at least one opening comprises two openings with a first opening being circular and a second opening being oval.

8. The assembly according to claim 7 including a protrusion that surrounds each of the first and second openings, with each protrusion being provided on a side of the carrier part, which after mounting the carrier part to the door interior part, faces away from the door interior part.

9. The assembly according to claim 1 wherein the at least one opening comprises two circular openings.

10. The assembly according to claim 9 including a protrusion that surrounds each of the two circular openings, with each protrusion being provided on a side of the carrier part, which after mounting the carrier part to the door interior part, engages on the door interior part.

11. The assembly according to claim 1 wherein the carrier part comprises a window lifter rail and the door interior part comprises a vehicle door module.
